(19) United States
(12) Patent Application Publication
(10) Pub. No.: US 2012/0107059 A1
(43) Pub. Date: May 3, 2012

(54) APPARATUS AND METHOD FOR DISPENSING FLOWABLE SOLID MATERIAL

(75) Inventors: Bob HOWLAND, Devon, PA (US); Loren Peachey, Port Royal, PA (US); Jim Cronin, Chadds Ford, PA (US); John Burrows, Wayne, PA (US); Robert J. Burtch, New Lothrop, MI (US)

(73) Assignee: ENERGEX PELLET FULE, INC., Mifflintown, PA (US)

(21) Appl. No.: 12/917,657

(22) Filed: Nov. 2, 2010

(51) Int. Cl. B65G 53/58

(52) U.S. Cl. 406/84

(57) ABSTRACT

The invention is directed to a method and device for delivering flowable solid material from a first location to a second location. The device has a receiving end which receives the flowable solid material therein and a discharge end which discharges the flowable solid material therefrom. An outlet opening is connected to a vacuum assembly which draws airflow from the device through the outlet opening, thereby drawing fine contaminants associated with the flowable solid material into the vacuum assembly. The airflow drawn from the device reduces the speed of the flowable solid material, allowing the flowable solid material to be discharged from the discharge end at a speed which will not damage the flowable solid material and which will minimize the amount of fine contaminants introduced to the air surrounding the discharge end.

### FIELD OF THE INVENTION

The present invention relates to a system and device for transferring flowable solid material. Specifically, in the preferred applications the invention concerns an apparatus and method for transfer of flowable solid material from one location to another.

### BACKGROUND OF THE INVENTION

Systems which use flowable solid material (herein “flowable solids,” “particulates,” or variants thereof) are known. One illustration of this type of systems is a stove that burns solid particulate fuels such as wood products (e.g., pellets, chips, etc.), grains (e.g., shelled corn, barley, wheat, etc.), and pulverized coal for home heating are very popular. These stoves typically have a hopper or holding/storage bin for the fuel and a fuel supply or feed system that transports the fuel from the hopper to the fire chamber to be burned. Some examples of feed systems include reciprocal pushers utilizing a pusher block or flat plates welded together, rotating cups and/or augers to move the fuel.

Flowable solid materials include, inter alia, agricultural grains, fertilizers, herbicides, pesticides, and synthetics in pellet or granular form. Flowable solids are frequently handled in bulk; and, consequently, specialized technologies are needed for transporting, storing, and transferring them.

These solid particulate fuels must be transported and delivered to the storage bin. Conventional methods of transporting and transferring the solids have been less than fully acceptable. One conventional method involves both transporting and transferring the solid material in barrels. Handling barrels is quite difficult, and loss of solid material during transfer may occur when barrels are used. This is due to their size, shape, and weight. Conventional barrels are quite heavy and have large openings at their top. When transferring material from a barrel to another container, spillage may occur or dust (airborne) may be generated.

Another conventional method of transferring the solids uses flexible sacks holding 100 pounds or more of the solid material. There are a number of problems associated with use of these sacks. In particular, the sacks are subject to breakage during shipping, thus leading to spillage and loss of product. In addition, large shipments require a large number of sacks, each of which must be filled, transported and stacked. Also, loss of material or dust generation may accompany transfer of the solids from the sacks to a container.

Another method of transferring the particulate solids uses enclosed columns or conduits, with the conduits having a discharge chute or opening at the free end thereof. The movement or flow of the solids is analogous to fluid flow, and entrained air frequently causes a cloud of dust to be generated at the discharge end of the conduit. This dust can cause issues and concerns for the surrounding area, the operator and the feed system.

Two basic techniques have been utilized to reduce the quantity of airborne dust emitted during the discharge delivery, one being to reduce or prevent the generation, the second being to collect or capture the dust, or otherwise control the environment in which the dust generation occurs. The present system utilizes a combination of these two basic techniques, including the utilization of a vacuum and piping for collection of dust, along with the generation of a flow pattern which reduces the severity of discharge of the grain solid materials from the free end of the conduit.

In the past, attempts have been made to control dust emission by immersing or otherwise burying the delivery spout into the solid material accumulated at the end of the conduit. Still another technique involves controlling dust by covering the discharge area with a tarpaulin, hood or the like, and controllably exhausting the air outwardly through a remote collection system. Each of these techniques involves difficulties, such as causing a clogging of the spout or conduit, failure to significantly reduce the emission of dust, or imposing limitations on the type of conduit or receivers used.

Therefore, it would be beneficial to provide a compact and durable delivery system which could efficiently and easily deliver solid material from a transport mechanism to a storage bin while controlling the amount of dust discharged to the surrounding environment and limiting the build-up of dust and debris in the feed system. In addition to effective dust control, it would also be beneficial to provide a system which causes little, if any, damage to the solid material passing through.

### SUMMARY OF THE INVENTION

One aspect of the invention is directed to a device for delivering flowable solid material from a first location to a second location. The device has a receiving end, a discharge end and an outlet opening. The receiving end receives the flowable solid material therein and the discharge end discharges the flowable solid material therefrom. The outlet opening is connected to an assembly which draws airflow from the device through the outlet opening. Airflow drawn from the device through the outlet opening draws fine contaminants associated with the flowable solid material into the assembly. The airflow drawn from the device is at least partially drawn in a direction which is divergent to the direction of the movement of the flowable solid material to reduce the speed of the flowable solid material and allow the flowable solid material to be discharged from the discharge end at a speed which will not damage the flowable solid material and which will minimize the amount of fine contaminants introduced to the air surrounding the discharge end.

Another aspect of the invention is directed to a delivery system for delivering flowable solid material from a first location to a second location. The delivery system has intake tubing, a discharge device, a blower assembly and a draw assembly. The intake tubing is positioned to cooperate with the flowable solid material at the first location. The discharge device is positioned proximate the second location. The discharge device has a receiving end, a discharge end and an outlet opening. The receiving end is connected to the intake tubing for receiving the flowable solid material therein and the discharge end discharges the flowable solid material therefrom. The blower assembly is attached to the intake tubing and provides airflow through the intake tubing to move the flowable solid material from the first location to the discharge device. The draw assembly is attached to the outlet opening. The draw assembly draws airflow from the discharge device through the outlet opening. Airflow drawn from the device through the outlet opening draws fine contaminants associated with the flowable solid material into the draw assembly. The airflow drawn from the device is at least partially drawn in a direction which is divergent to the direction of the movement of the flowable solid material to reduce the speed of the flowable solid material and allow the flowable solid material to be discharged from the discharge end at a speed which will not damage the flowable solid material and which will minimize the amount of fine contaminants introduced to the air surrounding the discharge end.

Another aspect of the invention is directed to a method for delivering flowable solid material from a first location to a second location. The flowable solid material is moved into a receiving end of a discharge apparatus through the use of an airflow stream. The airflow stream and fine contaminants are drawn through an outlet opening. The flowable solid material is then discharged from a discharged end of the discharge apparatus. Drawing the airflow stream through the outlet opening draws the airflow in a direction which is partially divergent from the direction of the movement of the flowable solid material to reduce the speed of the flowable solid material and allow the flowable solid material to be discharged from the discharge end at a speed which will not damage the flowable solid material.

The delivery system, discharge device and method of the present invention have several advantages. Due to the reverse pull applied to the flowable solid material by the vacuum stream, the integrity of the flowable solid material is maintained, as the flowable solid material does not encounter forces or velocities that cause the material to break apart or degrade, particularly as discharge. Another advantage is the elimination of airborne dust or other fine contaminants being released into the surrounding environment, thereby eliminating a threat to the safety of workers and consumers. As the fine contaminants are effectively removed from the flowable solid material at several locations, the discharge of the flowable solid material does not cause the fine contaminants to be released. Additionally, due to the use of the vacuum through the intake tube, the loss of material through damage to the intake tube when transferring from one location to another location is essentially eliminated.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective representation of an embodiment of a dispensing or transfer system of the present invention.

FIG. 2 is an enlarged plan view of a first embodiment of a discharge apparatus or device for use in the transfer system shown in FIG. 1.

FIG. 3 is an enlarged plan view of the discharge apparatus or device similar to that shown in FIG. 2, illustrating the air flow through the discharge apparatus.

FIG. 4 is a cross-sectional view taken along line 4-4 of FIG. 2.

FIG. 5 is a cross-sectional view taken along line 5-5 of FIG. 2.

FIG. 6 is a diagrammatic view of a second embodiment of a discharge apparatus or device for use in the transfer system shown in FIG. 1.

FIG. 7 is a top view of the discharge apparatus of FIG. 6, illustrating the movement of the flowable solid material.

### DETAILED DESCRIPTION OF THE INVENTION

Various industries and consumers make use of a variety of flowable solid materials, which include, but are not limited to, friable solid materials. In particular, consumers use solid particulate fuels such as wood pellets or grains for heating. The delivery of such solid particulate fuels or flowable solid materials from a first location, such as a transport vehicle, to a second location, such as a storage bin, presents various concerns. One concern relates to the integrity of the pellets or other flowable solid material. As the material is transported, it is desirable to transport the material in a manner that does not cause the material to break apart or degrade. Another concern relates to the generation and release of airborne dust or other fine contaminants posing a threat to the safety of workers and consumers. Additionally, the loss of material through spillage from damage to the equipment when transferring from one location to another location is always a concern.

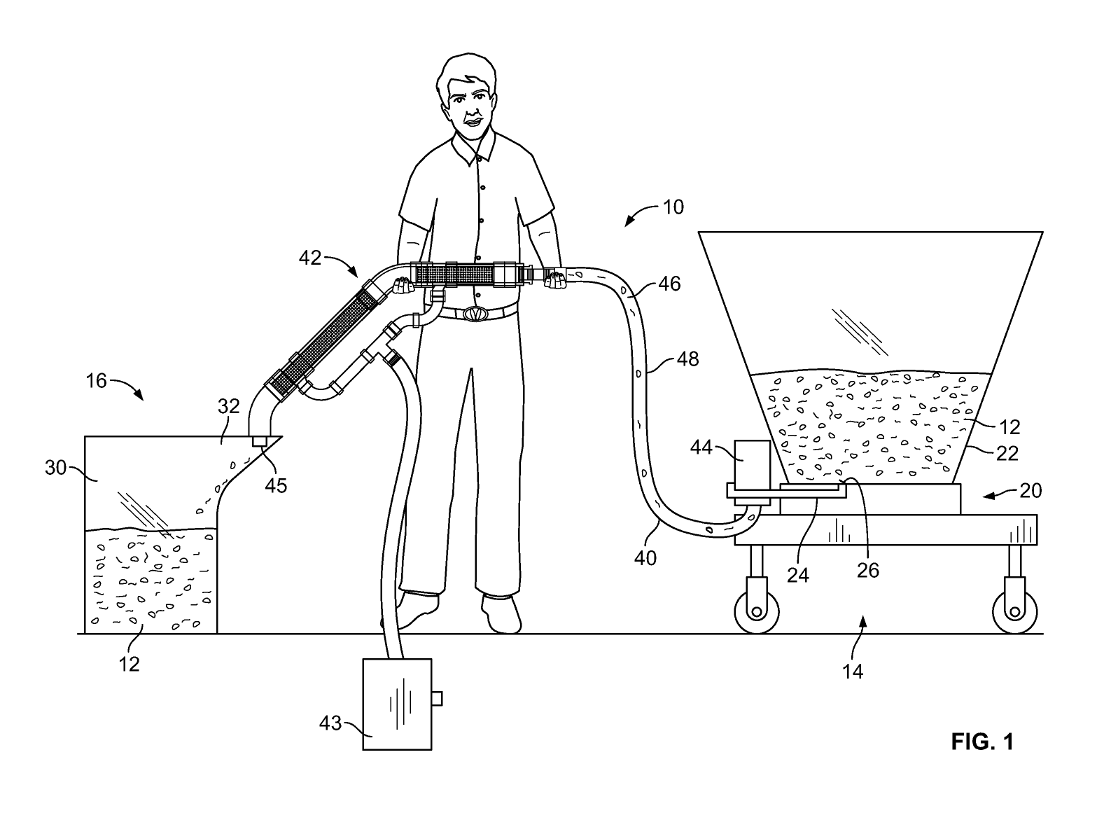

The discharge apparatus and transfer system shown and described herein address these concerns. Referring to FIG. 1, a transfer system 10 is shown for conveying a flowable solid material 12 from a first location 14 to a second location 16. In the embodiment shown, the first location 14 is a delivery vehicle 20 with a high-walled truck bed 22 which carries the flowable solid material 12 from one site to a second site. In the embodiment shown, the flowable solid material is wood pellets 12, but other materials can be used without departing from the scope of the invention. The second location 16 shown is a storage bin 30 which is located in a house, garage or yard (not shown) of a consumer. Although the first location 14 is shown as the bed 22 of a truck 20, it will be understood that any of a variety of other containers, including large collapsible storage containers, barrels, bags, sacks, bins or the like, may be utilized. Similarly, although the second location 16 is shown as a storage bin 30, it will be understood that a variety of other containers, including barrels, bags, sacks, bins or the like, may be utilized in a variety of commercial, industrial or residential environments. Therefore, the system 10 can be used to accomplish transfers of the flowable solid material between a variety of containers and locations. It is an advantage, however, that transfer system 10 can be sized, shaped, and configured for use in the field for typical conveyances that might be needed.

As best shown in FIG. 1, the delivery vehicle has feed channel 24 located at the bottom of the truck bed 22. A gate or partition 26 prevents the pellets 12 from moving into the feed channel 24 when the gate 26 is in the closed position. Other types of feed systems and truck beds can be used without departing from the scope of the invention. The storage bin 30 has a receiving area 32 into which the pellets 12 are received. Other types of receiving areas and storage bins can be used without departing from the scope of the invention. The delivery vehicle 20 and storage bin 30 will be described in more detail below as they relate to the operation of the of the exemplary transfer system 10 shown herein.

The exemplary transfer system 10 for transporting flowable solid material 12 from the delivery vehicle 20 to the storage bin 30 generally comprises an intake tube 40, a discharge apparatus or device 42, an air draw or vacuum assembly 43, a blower assembly 44 and a discharge tube 45. The intake tube 40 may be any tube which has an inner opening 46 having a diameter large enough to allow for the pellets 12 to be transported therethrough. The intake tube 40 may be of varying lengths depending upon the particular application. The intake tube 40 may be flexible, rigid or a combination thereof. However, the intake tube 40 must have an outer wall 48 of sufficient strength to withstand the transport of the pellets 12 by the airflow stream generated by the blower assembly 44. The blower assembly 44 generally comprises a blower which draws air from the ambient to create a sufficient airflow stream at sufficient velocity and pressure to move the pellets 12. The blower assembly 44 may comprise a conventional engine/blower system, or any of a variety of alternative systems.

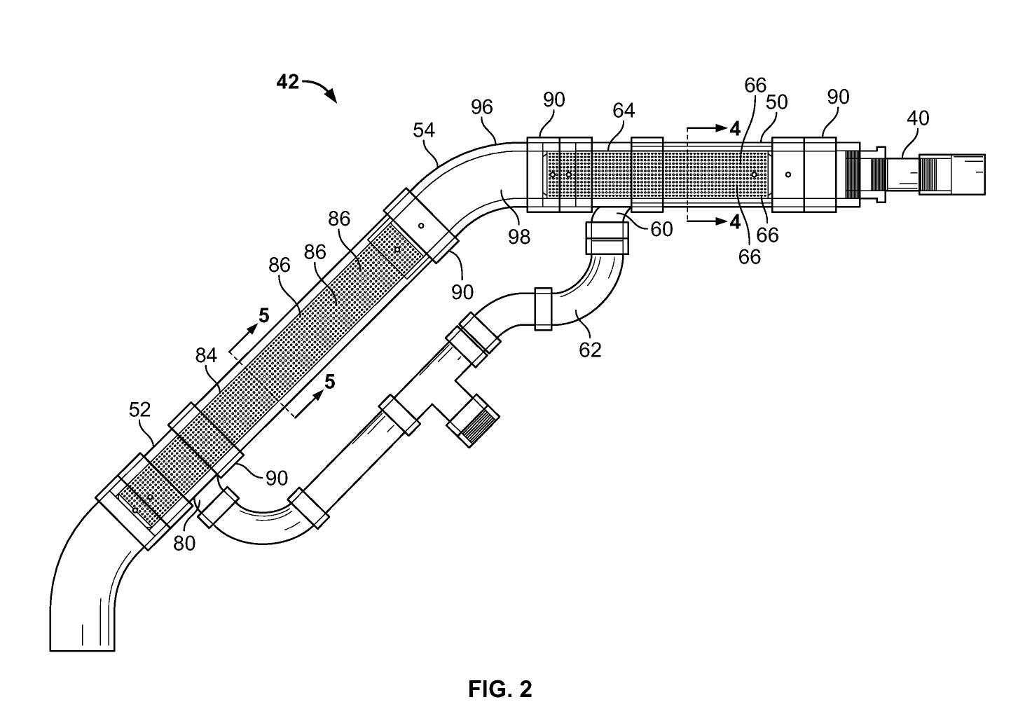

Referring to FIG. 2, the discharge apparatus or device 42 has a receiving end 50, a discharge end 52 and a transition portion 54 positioned between the receiving end 50 and the discharge end 52. The receiving end 50 is connected to the intake tube 40, thereby allowing the flowable solid material to flow in the airflow generated by the blower assembly 44 from the intake tube 40 into the discharge device 42. The discharge end 52 is connected to the discharge tube 45, thereby allowing the flowable solid material to flow from the discharge device 42 to the discharge tube 45, as will be more fully described.

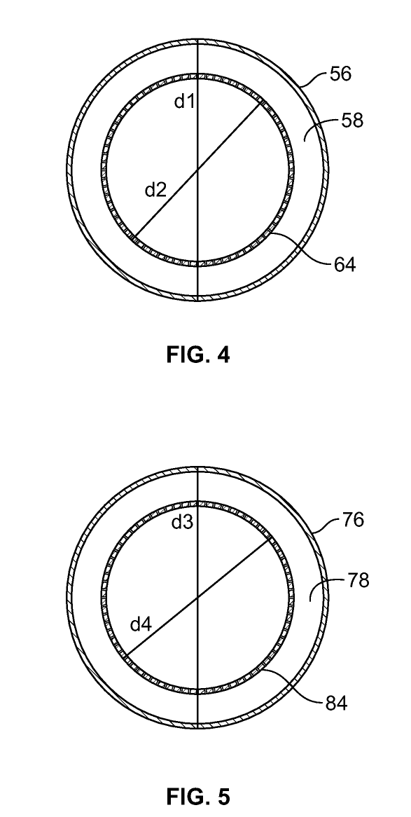

The receiving end 50 has an outer wall 56 (FIG. 4) and an inner opening 58 (FIG. 4) through which the flowable solid material 12 is moved. An outlet 60 is provided in the outer wall 56. The outlet 60 is connected to a vacuum tube 62 which is connected to the vacuum assembly 43. In the embodiment shown, the vacuum tube 62 at the outlet 60 is divergent relative to the outer wall 56 and relative to the path of movement of the pellets or flowable solid material 12. While the angle shown between the vacuum tube 62 at the outlet 60 and outer wall 56 is acute, the vacuum tube 62 at the outlet 60 may form other angles relative to the outer wall 56 and relative to the path of movement of the pellets or flowable solid material 12.

The vacuum assembly 43 generally comprises a blower which draws air from the vacuum tube 62 to create a sufficient vacuum draw and blows or discharges it into the environment after it has been filtered. The vacuum assembly 43 may comprise a conventional vacuum system, or any of a variety of alternative systems.

A filter 64 extends across the outlet 60. The filter 64 has a cylindrical configuration with a diameter d₂ (FIG. 4) that is slightly smaller than the diameter d₁ (FIG. 4) of the inner opening 58 of the receiving end 50. The filter 64 has openings 66 spaced about its entire circumference and along its length. The openings 66 are dimensioned to be smaller than the individual pellets 12 which are moved through the transfer system 10. The filter 64 may be made from any materials having the strength characteristics required to withstand contact with the pellets 12 as they are moved through the receiving end 50.

The discharge end 52 has an outer wall 76 (FIG. 5) and an inner opening 78 (FIG. 5) through which the flowable solid material 12 is moved. An outlet 80 is provided in the outer wall 76. The outlet 80 is connected to a vacuum tube 62 which is connected to the vacuum assembly 43. The vacuum tube 62 at the outlet 80 is shaped to form an acute angle relative to the outer wall 76 and relative to the path of movement of the pellets or flowable solid material 12.

A filter 84 extends across the outlet 80. The filter 84 has a cylindrical configuration with a diameter d₄ (FIG. 5) that is slightly smaller than the diameter d₃ (FIG. 5) of the inner opening 78 of the discharge end 52. The filter 84 has openings 86 spaced about its entire circumference and along its length. The openings 86 are dimensioned to be smaller than the individual pellets 12 which are moved through the transfer system 10. The filter 84 may be made from any materials having the strength characteristics required to withstand contact with the pellets 12 as they are moved through the discharge end 52.

The transition portion 54 connects the receiving end 50 and the discharge end 52. The transition portion 54 has an arcuate configuration with an outer wall 96 and an inner opening 98. The diameters and shape of the outer walls 56, 76, 96 are essentially the same, as are the diameters and shape of the inner openings 58, 78, 98. In the embodiment shown, the transition portion 54 is connected to the receiving end 50 and the discharge end 52 by pipe couplings 90 which are maintained in position using screws (not shown), adhesives, or other known methods. Alternatively, the discharge device may also be molded in one piece or manufactured using other conventional methods.

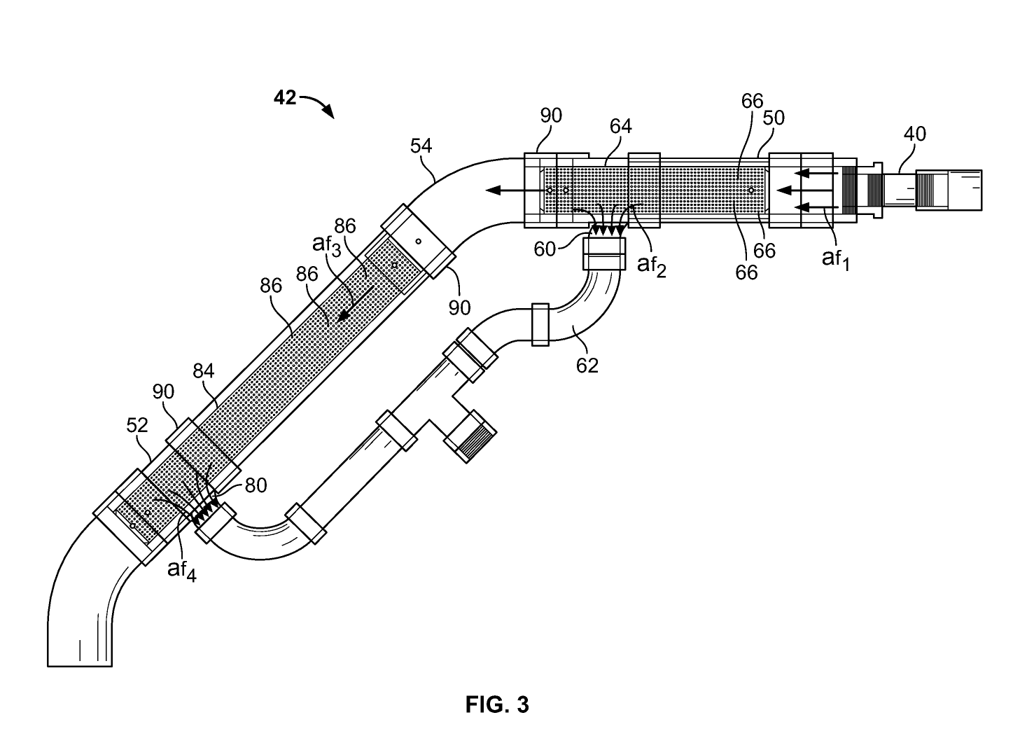

In use, the intake tube 40 of the transfer system 10 is moved into engagement with the feed channel 24 of the delivery vehicle 20. The gate 26 is opened and the pellets 12 are moved by gravity, or other known means, into the feed channel 24. The blower assembly 44 is engaged, creating the appropriate airflow through the transfer system 10. The pellets 12, carried by an air stream af₁ (FIG. 3) travel through the intake tube 40 and into the receiving end 50 of the discharge device 42. In the receiving end 50, the vacuum generated by the vacuum assembly 43 provides a reverse or negative pressure to the airflow or air stream af₁ and the pellets 12, thereby negating or drawing off a portion of the airflow, as shown by af₂, causing the forward velocity of the pellets 12 to be slowed.

The filter 64 prevents the pellets 12 from passing through the outlet 60 and entering into the vacuum tube 62. The openings 66 of the filter 64 allow the vacuum stream and any fine contaminants, such as dust, small particulates, etc. to be drawn therethrough. This allows a portion of the fine contaminants to be removed from the pellets 12, before the pellets 12 are moved to the transition portion 54. Because the filter 64 has a smaller diameter than the inner opening 58, space is provided between the filter 64 and the wall of the inner opening 58. This allows for the vacuum to interact with a larger surface area of the filter 64, which allows more fine contaminants to be drawn through the filter 64 and outlet 60. The fine contaminants are drawn through the vacuum tube 62 to a filter (not shown) in which the contaminants are removed from the air in any known manner.

The receiving end 50 and filter 64 have a generally straight configuration. This allows a portion of the airflow stream af₂ (FIG. 3) to be drawn off without causing the pellets 12 to collide with the walls of filter 64 or inner wall 58 of the receiving end 50, thereby preventing damage to the pellets 12 and maintaining the integrity of the pellets 12 through the receiving end 50.

As only a portion of the airflow stream af₂ (FIG. 3) is negated or drawn off by outlet 60, the pellets 12 continue to be drawn through the transition portion 54 toward the discharge end 52 by the remaining airflow stream af₃ (FIG. 3). However, as a portion of the airflow stream is drawn off by outlet 60, the pellets' 12 speed along the axis of movement is slowed for two reasons. First, less of the airflow stream is provided. Second, as a portion of the airflow stream is drawn off, the portion of the airflow stream that is drawn off causes a reverse pull on the pellets 12 which move past the outlet 60, thereby slowing the pellets' 12 forward motion. By adjusting or controlling the strength and/or flow of the vacuum, the amount of reverse pull on the pellets 12 can be controlled.

The pellets 12 continue to be forced through the transition portion 54 and into the discharge end 52 by the remaining airflow stream af₃ (FIG. 3) generated by the blower assembly 44. In the discharge end 52, the pellets 12 are separated from the remaining portion of the airflow stream. The remaining portion of the airflow stream af₄ (FIG. 3) is drawn off from the inner opening 78 (FIG. 5) of the discharge end 52 through the outlet 80. Adjusting or controlling the strength and/or flow of the vacuum allows for the velocity of the airflow stream to be drawn off to be controlled. The filter 84 prevents the pellets 12 from passing through the outlet 80 and entering into the vacuum tube 62. The openings 86 of the filter 84 allow the remaining airflow stream af₄ (FIG. 3) and any remaining fine contaminants, such as dust, small particulates, etc., to be drawn therethrough. This allows the remaining portion of the fine contaminants to be removed from the pellets 12, before the pellets 12 are discharged through the discharge tube 45 prior to the pellets 12 being released from the transfer system 10. Because the filter 84 has a smaller diameter than the inner opening 78, space is provided between the filter 84 and the wall of the inner opening 78. This allows for the vacuum to interact with a larger surface area of the filter 84, which allows more fine contaminants to be drawn through the filter 84 and outlet 80. The fine contaminants are drawn through the vacuum tube 62 to a filter (not shown) in which the contaminants are removed from the air in any known manner.

The discharge end 52 and filter 84 have a generally straight configuration. This allows the remaining portion of the vacuum stream to be drawn off without causing the pellets 12 to collide with the walls of filter 84 or inner wall 78 of the discharge end 52, thereby preventing damage to the pellets 12 and maintaining the integrity of the pellets 12 through the discharge end 52. By adjusting or controlling the strength and/or flow of the vacuum, the amount of reverse pull on the pellets 12 can be controlled to produce the desired results.

As the remaining portion of the airflow stream is drawn off by outlet 80, the forward velocity of the airflow and pellets 12 is eliminated and the pellets 12 continue out of the discharge tube 45 by gravity. As the remaining portion of the airflow stream is drawn off by outlet 80, the pellets' 12 speed along the axis of movement is slowed for two reasons. First, little or no remaining airflow stream is provided. Second, as the remaining portion of the airflow stream is drawn off, the remaining portion of the airflow stream that is drawn off causes a reverse pull on the pellets 12 which move past the outlet 80, thereby slowing or essentially eliminating the pellets' 12 forward motion.

The pellets 12 are discharged into the storage bin 30 through the discharge tube 45. The pellets 12 are moved through the discharge tube 45 to the storage bin 30 under the influence of gravity, or through other known means.

It is foreseen that in some instances, means for automatically detecting an amount of material entering the intake tube 40 or exiting the discharge tube 45 may be useful. The detection mechanism (not shown) may be of any known type which measures volume or which detects relative levels of material in the first location 14 or the second location 16.

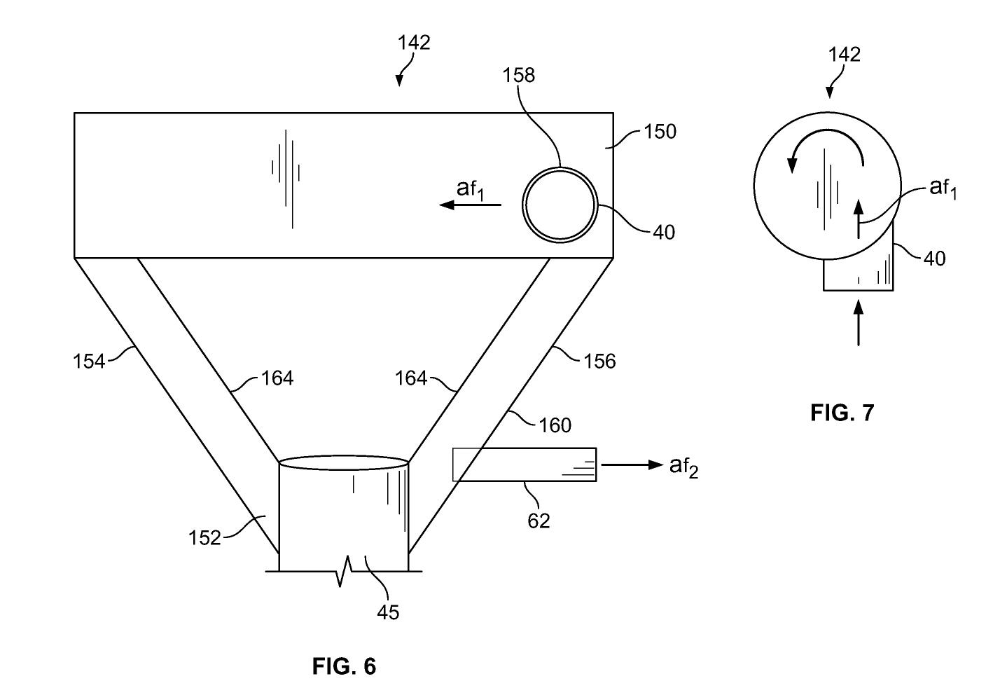

Referring to FIG. 6, an alternate exemplary embodiment is shown. In this exemplary embodiment, the discharge apparatus or device 142 has a receiving end 150, a discharge end 152 and a transition portion 154 positioned between the receiving end 150 and the discharge end 152. The receiving end 150 is connected to the intake tube 40, thereby allowing the flowable solid material to flow in the airflow generated by the blower assembly 44 from the intake tube 40 into the discharge device 142. The discharge end 152 is connected to the discharge tube 45, thereby allowing the flowable solid material to flow from the discharge device 142 to the discharge tube 45, as will be more fully described.

The discharge device 142 has a conical configuration, with receiving end 150 located the upper end of the cone, the cross-section of which has the larger diameter. The discharge end 152 is positioned below (as viewed in FIG. 6) the receiving end 150. The diameter of a cross-section of the discharge end 152 is smaller than the diameter of the receiving end 150. The receiving end 150 has an opening 158 through which the flowable solid material 12 is moved.

An outlet 160 is provided on the discharge device 142. In the embodiment shown in FIG. 6, the outlet 160 is provided proximate the discharge end 152, but other configuration are possible without departing from the scope of the invention. The vacuum tube 62 extends from the outlet 160 and is connected to the vacuum assembly 43. The outlet 160 and vacuum tube 62 are divergent relative to the outer wall 156 of the discharge device 142 and relative to the path of movement of the pellets or flowable solid material 12 therein. In the embodiment shown, only one outlet 160 is provided, however, multiple outlets may be provided without departing from the scope of the invention.

A conical filter 164 is provided in the discharge device 142. The filter 164 extends across the outlet 160. The filter 64 has a conical configuration with dimensions smaller than the dimensions of the inside conical opening of the discharge device 142, thereby allowing the filter to be offset from the walls of the conical opening. The filter 164 has openings (not shown) spaced about its entire circumference and along its length. The openings are dimensioned to be smaller than the individual pellets 12 which are moved through the transfer system 10. The filter 164 may be made from any materials having the strength characteristics required to withstand contact with the pellets 12 as they are moved through the discharge device 142.

In use, the pellets 12 are moved from the delivery vehicle 20 though the intake tube 40 and into the receiving end 150 by means of the airflow af₁ as previously described. The airflow af₁ generated by the blower assembly 44 causes the pellets 12 to be discharged into the discharge device 142 at the receiving end 150. The airflow af₁ causes the pellets 12 to move about the circumference of the inside conical opening, as represented in FIG. 7. In addition, the pellets 12 are influenced by gravity which facilitates the movement of the pellets from the receiving end 150 to the discharge end 152.

As this occurs, the airflow af₁ and debris are drawn through the outlet 160 by the vacuum generated by the vacuum assembly 43. This provides a reverse or negative pressure to the airflow or air stream af₁ and the pellets 12, thereby negating or drawing off most or all of the airflow, as shown by af₂, causing the forward velocity of the pellets 12 to be slowed. In the embodiment shown, af₂ is essentially equal to af₁, but other relative relations between af₁ and af₂ can be used without departing from the scope of the invention.

Adjusting or controlling the strength and/or flow of the vacuum allows for the amount of the airflow stream to be drawn off to be controlled. The filter 164 prevents the pellets 12 from passing through the outlet 160 and entering into the vacuum tube 62. The openings 166 of the filter 164 allow the vacuum stream and any fine contaminants, such as dust, small particulates, etc. to be drawn therethrough. This allows the fine contaminants to be removed from the pellets 12, before the pellets 12 are moved to the discharge end 152. Because the filter 164 is offset from the walls of the conical opening, space is provided between the filter 164 and the wall of the conical opening. This allows for the vacuum to interact with a larger surface area of the filter 164, which allows more fine contaminants to be drawn through the filter 164 and outlet 160. The fine contaminants are drawn through the vacuum tube 62 to a filter (not shown) in which the contaminants are removed from the air in any known manner.

As the airflow stream is drawn off by outlet 160, the pellets' 12 speed along the axis of movement is slowed or essentially eliminating for two reasons. First, no forward airflow stream is provided. Second, as the airflow stream is drawn off, it causes a reverse pull on the pellets 12 thereby slowing the pellets' 12 forward motion. By controlling the angle at which the outlet 160 and vacuum tube 62 enters the discharge device 142, the amount of reverse pull on the pellets 12 can be controlled before the pellets 12 are discharged through the discharge tube 45 prior to the pellets 12 being released from the transfer system 10.

As the airflow stream is drawn off by outlet 160, the forward velocity of the airflow and pellets 12 is eliminated and the pellets 12 continue out of the discharge tube 45 by gravity. The pellets 12 are discharged into the storage bin 30 through the discharge tube 45. The pellets 12 are moved through the discharge tube 45 to the storage bin 30 under the influence of gravity, or through other known means.

Transfer systems as described may be utilized for conveyance of a variety of materials. Thus, they may: be constructed of various materials; be provided with various engine and blower systems; and be provided with a variety of sizes, shapes, etc. of hoses, conduits, and framework. They may be utilized to transfer relatively small particles, for example on the order of 7-8 million population per pound, or relatively large particulate materials. In general, such an arrangement will be capable of transferring about 200 pounds per minute of material, through a line size of about 2 inches diameter. A variety of engine/generator systems may be utilized to control such arrangements.

The transfer system 10 and discharge apparatus 42 of the present invention have several advantages. Due to the reverse pull applied to the flowable solid material by the vacuum stream, the integrity of the flowable solid material is maintained, as the flowable solid material does not encounter forces or velocities that cause the material to break apart or degrade, particularly at discharge. Another advantage is the elimination of airborne dust or other fine contaminants being released into the surrounding environment, thereby eliminating a threat to the safety of workers and consumers. As the fine contaminants are effectively removed from the flowable solid material at several locations, the discharge of the flowable solid material does not cause the fine contaminants to be released. Additionally, due to the use of the vacuum through the intake tube, the loss of material through damage to the intake tube when transferring from one location to another location is essentially eliminated.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A device for delivering flowable solid material from a first location to a second location, the device comprising:
a receiving end and a discharge end, the receiving end receives the flowable solid material therein, the discharge end discharges the flowable solid material therefrom,
an outlet opening, the outlet opening being connected to an assembly which draws airflow from the device through the outlet opening;
whereby airflow drawn from the device through the outlet opening draws fine contaminants associated with the flowable solid material into the assembly, the airflow drawn from the device is at least partially drawn in a direction which is divergent to the direction of the movement of the flowable solid material to reduce the speed of the flowable solid material and allow the flowable solid material to be discharged from the discharge end at a speed which will not damage the flowable solid material and which will minimize the amount of fine contaminants introduced to the air surrounding the discharge end.

2. The device as recited in claim 1, wherein a filter is provided which extends across the outlet opening, the filter having openings which are dimensioned to be smaller than each individual piece of the flowable solid material, thereby preventing each individual piece of the flowable solid material from being drawn through the outlet opening and into the assembly.

3. The device as recited in claim 2, wherein the filter is offset from a wall of the device, thereby allowing the filter to be spaced from the wall to allow more fine contaminants to be drawn through the outlet opening.

4. The device as recited in claim 3, wherein multiple outlet openings are provided, with each outlet opening having a filter which extends across the respective outlet opening, each of the filters having openings which are dimensioned to be smaller than each individual piece of the flowable solid material, thereby preventing each individual piece of the flowable solid material from being drawn through the multiple outlet openings and into the assembly.

5. The device as recited in claim 2, wherein the filter extends beyond the ends of the outlet openings, thereby allowing the air to be drawn from the flowable solid material over a greater area, thereby allowing the fine contaminants to be drawn from a larger volume of the device.

6. The device as recited in claim 1, wherein the airflow drawn through the outlet opening is controlled.

7. The device as recited in claim 1, wherein a transition portion is provided between the receiving end and the discharge end.

8. The device as recited in claim 1, wherein a first outlet is provided proximate the receiving end and a second outlet opening is provided proximate the discharge end.

9. A delivery system for delivering flowable solid material from a first location to a second location, the delivery system comprising:
intake tubing positioned to cooperate with the flowable solid material at the first location;
a discharge device positioned proximate the second location, the discharge device comprising a receiving end, a discharge end and an outlet opening, the receiving end connected to the intake tubing for receiving the flowable solid material therein, the discharge end discharges the flowable solid material therefrom;
a blower assembly attached to the intake tubing, the blower providing airflow through the intake tubing to move the flowable solid material from the first location to the discharge device;
a draw assembly attached to the outlet opening, the draw assembly draws airflow from the discharge device through the outlet opening;
whereby airflow drawn from the device through the outlet opening draws fine contaminants associated with the flowable solid material into the draw assembly, the airflow drawn from the device is at least partially drawn in a direction which is divergent to the direction of the movement of the flowable solid material to reduce the speed of the flowable solid material and allow the flowable solid material to be discharged from the discharge end at a speed which will not damage the flowable solid material and which will minimize the amount of fine contaminants introduced to the air surrounding the discharge end.

10. The delivery system as recited in claim 9, wherein a filter is provided which extends across the outlet opening, the filter having openings which are dimensioned to be smaller than each individual piece of the flowable solid material, thereby preventing each individual piece of the flowable solid material from being drawn through the outlet opening and into the draw assembly.

11. The delivery system as recited in claim 10, wherein the filter is offset from a wall of the device, thereby allowing the filter to be spaced from the wall to allow more fine contaminants to be drawn through the outlet opening.

12. The delivery system as recited in claim 11, wherein multiple outlet openings are provided, with each outlet opening having a filter which extends across the respective outlet opening, each of the filters having openings which are dimensioned to be smaller than each individual piece of the flowable solid material, thereby preventing each individual piece of the flowable solid material from being drawn through the multiple outlet openings and into the draw assembly.

13. The delivery system as recited in claim 10, wherein the filter extends beyond the ends of the outlet openings, thereby allowing the air to be drawn from the flowable solid material over a greater area, thereby allowing the fine contaminants to be drawn from a larger volume of the device.

14. The delivery system as recited in claim 9, wherein the airflow drawn through the outlet opening is controlled.

15. A method for delivering flowable solid material from a first location to a second location, the method comprising:
moving the flowable solid material into a receiving end of a discharge apparatus through the use of an airflow stream;
drawing the airflow stream and fine contaminants through an outlet opening;
discharging the flowable solid material from a discharged end of the discharge apparatus;
whereby drawing the airflow stream through the outlet opening draws the airflow in a direction which is partially opposed to the direction of the movement of the flowable solid material to reduce the speed of the flowable solid material and allow the flowable solid material to be discharged from the discharge end at a speed which will not damage the flowable solid material.

16. The method as recited in claim 15, wherein the airflow stream is drawn through a filter, the filter extending across the outlet opening, the filter having openings which are dimensioned to be smaller than each individual piece of the flowable solid material, thereby preventing each individual piece of the flowable solid material from being drawn into the outlet opening.

17. The method as recited in claim 16, wherein the filter is offset from a wall of the device, thereby allowing the filter to be spaced from the wall to allow more fine contaminants to be drawn through the outlet opening.

18. The method as recited in claim 17, wherein multiple outlet openings are provided, with each outlet opening having a filter which extends across the respective outlet opening, each of the filters having openings which are dimensioned to be smaller than each individual piece of the flowable solid material, thereby preventing each individual piece of the flowable solid material from being drawn through the multiple outlet openings.

19. The method as recited in claim 16, wherein the filter extends beyond the ends of the outlet openings, thereby allowing the air to be drawn from the flowable solid material over a greater area, thereby allowing the fine contaminants to be drawn from a larger volume of the device.

20. The method as recited in claim 15, wherein the airflow drawn through the outlet opening is controlled.
